(19) United States
(12) Patent Application Publication
(10) Pub. No.: US 2023/0004682 A1
(43) Pub. Date: Jan. 5, 2023

(54) TAMPER DETECTION SYSTEMS AND METHODS FOR ELECTRONIC DEVICES CARRIED BY MOBILE EQUIPMENT

(71) Applicant: Lenovo (United States) Inc., Morrisville, NC (US)

(72) Inventors: Fred Allison Bower, III, Morrisville, NC (US); Caihong Zhang, Shanghai (CN); Hui Zeng, Shanghai (CN); Haijun Xu, Shanghai (CN)

(21) Appl. No.: 17/364,132

(22) Filed: Jun. 30, 2021

(51) Int. Cl. G06F 21/86; G06F 21/62; G06F 21/81

(52) U.S. Cl. CPC G06F 21/86; G06F 21/62; G06F 21/81

(57) ABSTRACT

Tamper detection systems and methods for electronic devices carried by mobile equipment are disclosed. According to an aspect, a system includes an electronic device and a first sensor attached to the electronic device for detecting motion of the electronic device. The system includes a second sensor configured to detect motion of the mobile equipment to which the electronic device is attached. A tamper detection module receives data from the first sensor that indicates the detected motion of the electronic device. The tamper detection module receives data from the second sensor that indicates the detected motion of the mobile equipment. Further, the tamper detection module determines a difference between the detected motion of the electronic device and the detected motion of the mobile equipment. The tamper detection module determines a tamper condition for the electronic device based on the determined difference. A security action in response to determining the tamper condition.

### TECHNICAL FIELD

The presently disclosed subject matter relates generally to electronic devices. Particularly, the presently disclosed subject matter relates to tamper detection systems and methods for electronic devices carried by mobile equipment.

### BACKGROUND

Security of electronic devices has become more important over time as they are often relied upon to store sensitive data. For example, servers may store financial or technology information that should be kept secret. In the case of data centers, servers are stored in a secured environment where it is difficult for a someone to tamper with a server or otherwise physically remove a server to obtain the stored data or to steal the server.

In many instances, a computing device, such as a server, may include a security feature for preventing data theft or tampering by physical intrusion. As an example, the computing device may include use of accelerometers and gyroscopic sensors to detect changes in orientation of the computing device. The accelerometers and sensors may detect motion that indicates that the device has been dismounted from a wall and transferred to a tabletop for inspection. When this motion is detected, the computing device may take steps to prevent access to its stored data.

Edge computing applications presents additional challenges for securing computing devices and their data. In these applications, there can be a greater likelihood of tampering, so there is a greater need to protect sensitive data and to prevent theft. In an example, a retail store may have need for a server capability with commensurate security requirements for the financial data of its customers, but it cannot typically provide as much site security as a dedicated data center can.

In view of the foregoing, there is an increasing need to prevent data access and tampering of computing device and other electronic devices.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a diagram of mobile equipment carrying an electronic device with a tamper detection system in accordance with embodiments of the present disclosure;

FIG. 2 is another diagram of mobile equipment carrying an electronic device with a tamper detection system in accordance with embodiments of the present disclosure;

FIG. 3 is a flow diagram of an example method for tamper detection of an electronic device in accordance with embodiments of the present disclosure;

FIG. 4 is a block diagram of a tamper detection system in accordance with embodiments of the present disclosure; and

FIG. 5 is a flow diagram of another example method for tamper detection of an electronic device in accordance with embodiments of the present disclosure.

### SUMMARY

The presently disclosed subject matter relates to tamper detection systems and methods for electronic devices carried by mobile equipment. According to an aspect, a system includes an electronic device configured for attachment to mobile equipment. The system also includes a first sensor attached to the electronic device and configured to detect motion of the electronic device. Further, the system includes a second sensor configured for attachment to the mobile equipment and configured to detect motion of the mobile equipment. The system also includes a tamper detection module configured to receive data from the first sensor that indicates the detected motion of the electronic device. The tamper detection module is also configured to receive data from the second sensor that indicates the detected motion of the mobile equipment. Further, the tamper detection module is configured to determine a difference between the detected motion of the electronic device and the detected motion of the mobile equipment based on the received data. The tamper detection module is also configured to determine a tamper condition for the electronic device based on the detected motion of the electronic device and based on the determined difference. Further, the tamper detection module is configured to implement a security action in response to determining the tamper condition.

According to another aspect, a method includes detecting motion of an electronic device attached to mobile equipment. The method also includes detecting motion of the mobile equipment. Further, the method includes determining a difference between the detected motion of the electronic device and the detected motion of the mobile equipment. The method also includes determining a tamper condition for the electronic device based on the detected motion of the electronic device and based on the determined difference. Further, the method includes implementing a security action in response to determining the tamper condition.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Unless otherwise defined, all technical terms used herein have the same meaning as commonly understood by one of ordinary skill in the art to which this disclosure belongs.

The functional units described in this specification have been labeled as electronic devices. An electronic device may be implemented in programmable hardware devices such as processors, digital signal processors, central processing units, field programmable gate arrays, programmable array logic, programmable logic devices, cloud processing systems, or the like. The electronic devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the electronic device and achieve the stated purpose of the electronic device. In another example, an electronic device may be a server or other computer located within a data center. In another example, an electronic device may be used in an edge computing environment, such as being carried by an automobile.

An executable code of electronic device may be a single instruction, or many instructions, and may even be distributed over several different code segments, among different applications, and across several memory devices. Similarly, operational data may be identified and illustrated herein within the electronic device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of an electronic device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “electronic device”, “computing device” and “entities” should be broadly construed and should be understood to be interchangeable. They may include any type of electronic device, for example, a server, a desktop computer, a laptop computer, a smart phone, a cell phone, a pager, a personal digital assistant (PDA, e.g., with GPRS NIC), a mobile computer with a smartphone client, or the like.

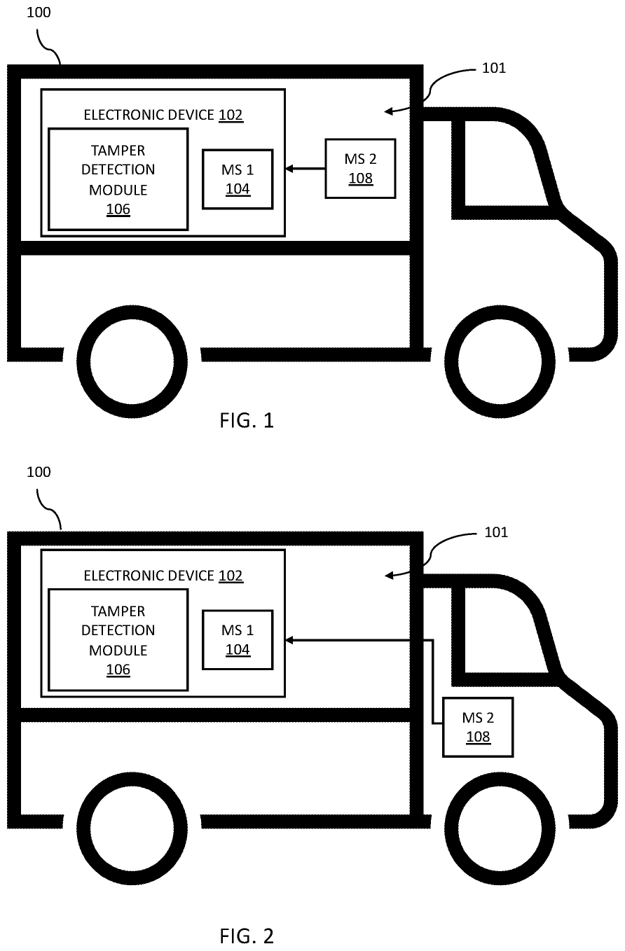

FIG. 1 illustrates a diagram of mobile equipment 100 carrying an electronic device 102 with a tamper detection system in accordance with embodiments of the present disclosure. Referring to FIG. 1, the mobile equipment 100 is a truck with a cargo area 101. The electronic device 102 is contained within the cargo area 101. Further, the electronic device 102 can be suitably mounted or attached to an assembly within the cargo area 101. In this example, the electronic device 102 is an edge computing device.

A motion sensor 104 can be into the electronic device 102 or otherwise associated with the electronic device 102. For example, the motion sensor 104 may be apart from the electronic device 102 but have a direct attachment to or at least a loose attachment to the electronic device 102 such that the motion of the motion sensor 104 is the same as or substantially matches the electronic device's 102 movement. In this example, the motion sensor 104 is resides within the electronic device 102. Alternatively, for example, the motion sensor 104 can be attached to the mounting assembly that attaches the electronic device 102 to the mobile equipment 102.

The motion sensor 104 or any other motion sensor described herein can be any suitable device for detecting its motion and generating output data representative of the detected motion. The motion sensor can be used for determining a direction of movement, a velocity, a speed, acceleration, and/or the like. For example, a motion sensor can be an accelerometer operable to measure acceleration. In another example, a motion sensor can be a gyroscope operable to measure orientation and/or angular velocity. In another example, a motion sensor can be a GPS sensor for detecting a position. The output data of the motion sensor may be suitably communicated to another device for processing. In this example, the motion sensor 104 can detect the motion of the electronic device 102 and output data representative of the motion of the electronic device 102.

The system includes another motion sensor 108 that is configured for attachment to the mobile equipment 100 and configured to detect motion of the mobile equipment 100. In this example, the motion sensor 108 is positioned within the cargo area 101. The motion sensor 108 can be attached to an interior wall of the cargo area 101 or any other suitable place for mounting. The motion sensor 108 is attached in this manner directly to the mobile equipment in order to accurately detect the motion of the mobile equipment 100, rather than the electronic device 102. Conversely, the other motion sensor 104 is attached directly to or is a part of the electronic device 102 in order to accurately detect the motion of the electronic device 102, rather than the mobile equipment 100.

The electronic device 102 can include a tamper detection module 106. The tamper detection module 106 may include suitable hardware, software, firmware, or combinations thereof for implementing the functionality described herein. For example, the tamper detection module 106 may include memory and one or more processors for implementing the functionality described herein. In some examples, the tamper detector module 106 may be implemented by a baseboard management controller (BMC) of a computer.

FIG. 2 illustrates another diagram of mobile equipment 100 carrying an electronic device 102 with a tamper detection system in accordance with embodiments of the present disclosure. Referring to FIG. 2, this system is similar to the system shown in FIG. 1 except for the placement of the motion sensor 108 being distanced farther from the electronic device 106. In this way, the comparison of the difference in the motion detected by the motion sensor 108 to motion sensor 104 can be more accurate. As described in further detail herein, the example methods for detecting tampering can include a comparison of the motion detected by the two sensors, such that an accurate comparison can better detect the tampering. In an example, the motion sensor 108 may be attached to a vehicle's chassis so that the effects of the suspension would be equal to both the electronic device 106 and the vehicle.

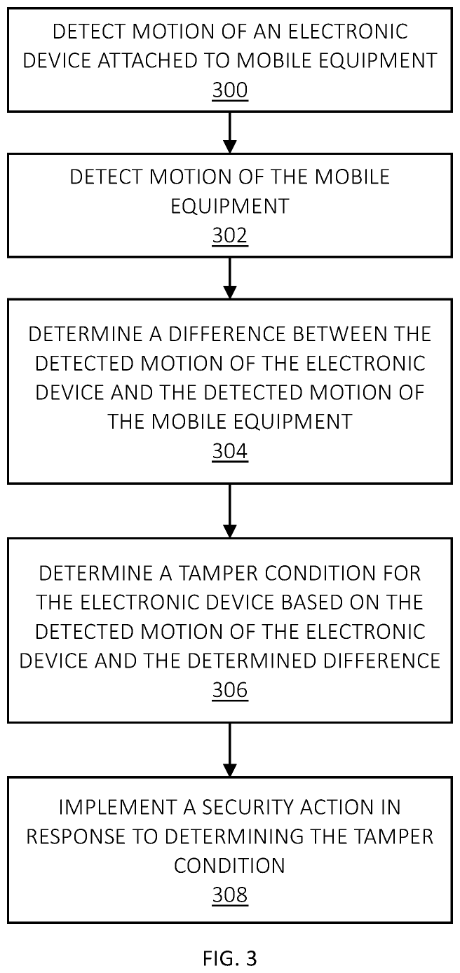

FIG. 3 illustrates a flow diagram of an example method for tamper detection of an electronic device in accordance with embodiments of the present disclosure. The method is described by example as being implemented by the system show in FIG. 1, although it should be understood that the method may be implemented by any suitable system.

Referring to FIG. 3, the method includes detecting 300 motion of an electronic device attached to mobile equipment. For example, the motion sensor 104 can detect the motion of electronic device 102 and output a signal representative of the detected motion. The tamper detection module 106 can receive the output signal and store the signal data. It is noted that the detected motion as described herein can be, for example, movement of the electronic device in a direction, acceleration of the electronic device, the like, or combinations thereof. The represented data may be any suitable measure of the detected motion. It is noted that suitable filtering may be used to reduce or eliminate noise from a motion sensor.

The method of FIG. 3 includes detecting 302 motion of the mobile equipment. Continuing the aforementioned example, the motion sensor 108 can detect the motion of mobile equipment 100 and output a signal representative of the detected motion. The tamper detection module 106 can receive the output signal and store the signal data. The motion sensor 108 may wirelessly communicate the output signal to the electronic device. For example, the wireless communication may be by use of Bluetooth, Zigbee or any other suitable wireless communication technique.

The method of FIG. 3 includes determining 304 a difference between the detected motion of the electronic device and the detected motion of the mobile equipment. Continuing the aforementioned example, the tamper detection module 106 can determine a difference between the detected motion of the electronic device 102 and the detected motion of the mobile equipment 100. For example, at a particular time or within a particular time period, the output data from the motion sensor 104 may indicate the movement or acceleration of the electronic device 102. Further, at the same time or timer period, the output data from the motion sensor 108 may indicate the movement or acceleration of the mobile equipment 100. Further, the tamper detection module 106 may subtract the indicated amount of movement or acceleration of the electronic device 102 from the indicated amount of movement or acceleration of the mobile equipment 100. The result of the subtraction is the determined difference of motion and indicates the actual relative movement of the electronic device 102.

The method of FIG. 3 includes determining 306 a tamper condition for the electronic device based on the detected motion of the electronic device and based on the determined difference. Continuing the aforementioned example, the tamper detection module 106 can use the determined difference of the mobile equipment 100 and the electronic device 102 to determine whether the electronic device 102 has been tampered with. For example, the difference may indicate a change in orientation and/or position of the electronic device 102. In this example, the orientation and/or position change can be compared to predetermined criteria. In response to meeting the criteria, the tamper condition can be determined. A tamper condition may be determined if, based on the orientation and/or position change, it may be deduced that the electronic device 102 has been removed from it mount or otherwise moved in an unauthorized manner. In an example, the motion change may indicate that the electronic device 102 has been moved from the wall of the cargo area to a table top. In an example, tampering may be detected based on a series of particular movements/orientations that have been detected. For example, the motions/orientations can indicate dismounting and opening of service panels or access to electronic access points (e.g., a USB port, Ethernet port, or other physical or electronic access point whereby device data can be extracted).

The method of FIG. 3 includes implementing 308 a security action in response to determining the tamper condition. Continuing the aforementioned example, the tamper detection module 106 can implement a security action in response to determining the tamper condition. For example, the tamper detection module 106 can implement a security action at the electronic device 102 in response to determining the tamper condition. Example security actions include, but are not limited to, disabling power activation for the electronic device or preventing access to data stored on the electronic device. In another example, the tamper detection module 106 can use a user interface (e.g., a display) to indicate a tamper condition at the electronic device or a remote computing device in response to determining a tamper condition. In another example, a security action may be preventing data access. Examples of action taken to prevent data access include, but are not limited to, encrypting the storage, deleting existing storage encryption keys from the local device to disable further access without central authority, or deleting data or destroying parts of the device to make it inoperable temporarily or permanently.

In accordance with embodiments, a tamper detection system as described herein may include techniques for preventing circumvention of the tamper detection. For example, the tamper detection module 106 and/or one or both motion sensors 104 and 108 may implement one or more anti-spoofing techniques to prevent them from being spoofed. In another example, the tamper detection module 106 may be configured to receive a secure instruction that indicates authorized access to the electronic device, and can disable implementation of a security action as described herein in response to receiving the secure instruction. In this example, it may be desired to disable the security action in the case of an authorized person, such as a technician, servicing the electronic device.

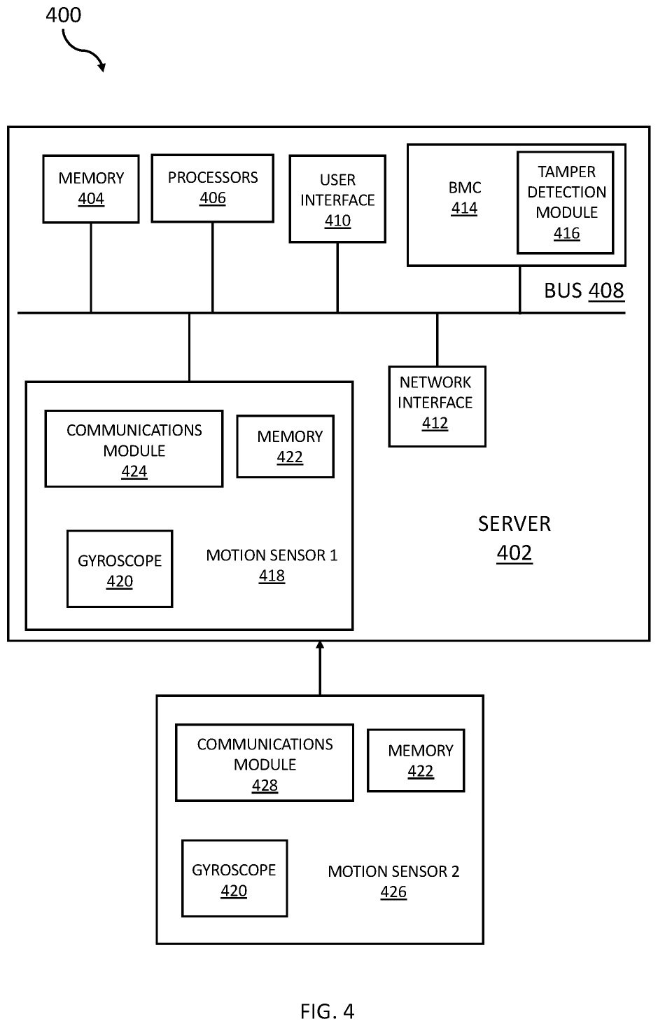

FIG. 4 illustrates a block diagram of a tamper detection system 400 in accordance with embodiments of the present disclosure. Referring to FIG. 4, the system 400 includes a server 402 having memory 404 and processors 406. The memory 404 and processors 406 are operably and communicatively connected to each other via a bus 408. Further, the server 402 can include a user interface 410 (e.g., display) for receipt and presentation of information to an operator. The server 402 can also include a network interface 412 for communication to other computing devices on a network.

With continuing reference to FIG. 4, the server 402 includes a BMC 414. A tamper detection module 416 having functionality described herein can be implemented by the BMC. The BMC can be operatively and communicatively connected to a motion sensor 418 via the bus 408. The motion sensor 418 can reside within and be attached to part of the server 402 for detecting motion of the server 402. Particularly, the motion sensor 418 can include a gyroscope 420 configured to detect a position and orientation of the server 402. Alternatively or in addition to for example, the motion sensor 418 can include an accelerometer for measuring acceleration of the server 418. Data generated by the gyroscope 420 that represents the measured motion may be stored in memory 422. The motion sensor 418 can include a communications module 424 configured to communicate the stored measurement data to the tamper detection module 416 via the bus 408. Alternatively, the motion sensor 418 may be directly connected to the BMC 414 for communication of the measurement data.

The system 400 shown in FIG. 4 also includes another motion sensor 426 located remote from the server 402. For example, the motion sensor 426 may be carried by the same mobile equipment that is carrying the server 402 but attached to a different part of the mobile equipment than the server 402. The motion sensor 426 may include gyroscope 420 configured to detect a position and orientation of the motion sensor 426 and thereby also a part of mobile equipment (e.g., cargo truck) that the motion sensor 426 is attached to. Alternatively or in addition to for example, the motion sensor 426 can include an accelerometer for measuring acceleration. Data generated by the gyroscope 420 that represents the measured motion may be stored in memory 422. The motion sensor 426 can include a communications module 428 configured to communicate the stored measurement data to the tamper detection module 416. The communications module 428 of the motion sensor 426 can communicate the measurement data to the tamper detection module 416 via any suitable communications techniques such as, but not limited to, wireless communication (e.g., Bluetooth or Zigbee).

With continuing reference to FIG. 4, the tamper detection module 416 can receive the measurement data from the motion sensor 418 and the motion sensor 426. The data received from the motion sensor 418 represents the detected motion of the server 402, and the data received from the motion sensor 426 represents the detected motion of the part of the mobile equipment that the motion sensor 426 is attached to. Subsequently, the tamper detection module 416 can determine a difference between the detected motion of the server 402 and the detected motion of the part of the mobile equipment that the motion sensor 426 is attached to. Also, the tamper detection module 416 can determine a tamper condition for the server 402 based on the detected motion of the server 402 and based on the determined difference. Subsequently, the tamper detection module 416 can implement a security action in response to determining the tamper condition. For example, the tamper detection module can initiate a lock of memory 404 and/or disable the server 402 from its ability to power on.

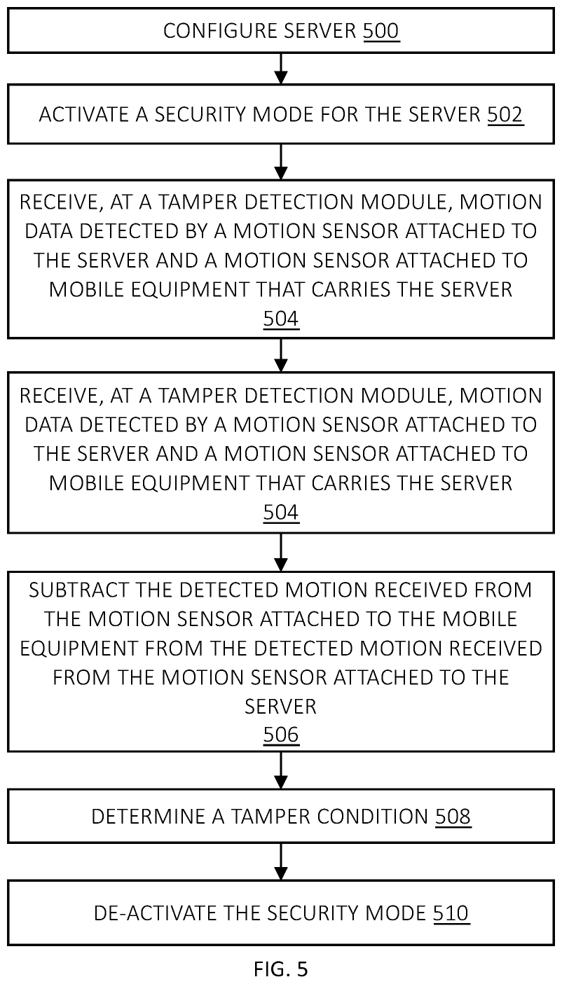

FIG. 5 illustrates a flow diagram of another example method for tamper detection of an electronic device in accordance with embodiments of the present disclosure. The method is described by example as being implemented by the system show in FIG. 4, although it should be understood that the method may be implemented by any suitable system.

Referring to FIG. 5, the method includes configuring 500 the server. For example, the server 402 can be powered on by an operator who is installing and configuring the server 402. The server 402 may be mounted in mobile equipment such as the cargo truck 100 shown in FIG. 2. At this stage, the server 402 may be in a mode for configuration and the operator may interact with the server 402 via the user interface 410. Further, security actions and/or the motion sensors 418 and 426 may be disabled in the configuration mode. The operator or another may mount or otherwise attach the motion sensor 426 to a part of the mobile equipment, such as with the cab of the truck 100 shown in FIG. 2 or another part of the truck (e.g., its chassis). The operator can suitably interact with the server 402 to confirm a communication connection between the motion sensor 426 and the tamper detection module 416.

The method of FIG. 5 includes activating 502 a security mode for the server. Continuing the aforementioned example, the operator can interact with the user interface 410 to turn on a security mode for the server 402 subsequent to it being configured. In the security mode, the motion sensors 418 and 426 can actively detect motion and communicate data representative of the detected motion to the tamper detection module 416 in accordance with embodiments of the present disclosure.

The method of FIG. 5 includes receiving 504, at a tamper detection module, motion data detected by a motion sensor attached to the server and a motion sensor attached to mobile equipment that carries the server. Continuing the aforementioned example, the communications module 426 can send to the tamper detection module 416, via the bus 408, the motion data detected by the gyroscope 420 of the motion sensor 418. Also, the communications module 428 can wirelessly communicate to the tamper detection module 416 the motion data detected by the gyroscope 420 of the motion sensor 426.

The method of FIG. 5 includes subtracting 506 the detected motion received from the motion sensor attached to mobile equipment carrying the server from the detected motion received from the motion sensor attached to the server. Continuing the aforementioned example, the motion data received from the motion sensor 426 is subtracted from the motion data received from the motion sensor 418. The tamper detection module 416 can implement the subtraction.

The method of FIG. 5 includes determining 508 a tamper condition for the server based on the result of the subtraction and based on the motion data received from the motion sensor attached to the server. Continuing the aforementioned example, the tamper detection module can determine the tamper condition based on the result of the subtraction and based on the motion data received from the motion sensor 418 in accordance with embodiments disclosed herein.

The method of FIG. 5 includes de-activating 510 the security mode based on authorized instruction. Continuing the aforementioned example, the tamper detection module 416 can receive secure instruction that indicates authorized access to the server 402. In an example, the user interface 410 may receive the instruction, such as an administrator's user name and password or other secure information for de-activating the security mode. In another example, the network interface 412 may receive a wired or wireless communication of secure instruction for de-activating the security mode. In response to receipt of the secure instruction, the tamper detection module 416 can de-activate the security mode, such as by disabling implementation of security actions.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A system comprising:
an electronic device configured for attachment to mobile equipment;
a first sensor attached to the electronic device and configured to detect motion of the electronic device;
a second sensor configured for attachment to the mobile equipment and configured to detect motion of the mobile equipment; and
a tamper detection module configured to:
receive data from the first sensor that indicates the detected motion of the electronic device;
receive data from the second sensor that indicates the detected motion of the mobile equipment;
determine a difference between the detected motion of the electronic device and the detected motion of the mobile equipment based on the received data;
determine a tamper condition for the electronic device based on the detected motion of the electronic device and based on the determined difference; and
implement a security action in response to determining the tamper condition.

2. The system of claim 1, wherein the electronic device is a computing device.

3. The system of claim 1, wherein the electronic device is a server.

4. The system of claim 1, wherein the mobile equipment is an automobile.

5. The system of claim 1, wherein the first sensor and the second sensor are accelerometers.

6. The system of claim 1, wherein the second sensor is configured to wirelessly communicate to the tamper detection module the data that indicates the detected motion of the mobile equipment.

7. The system of claim 1, wherein the tamper detection module is configured to indicate the tamper condition to an operator in response to determining the tamper condition.

8. The system of claim 1, wherein the tamper detection module is configured to implement a security action at the electronic device in response to determining the tamper condition.

9. The system of claim 8, wherein the security action comprises one of disabling power activation for the electronic device and preventing access to data stored on the electronic device.

10. The system of claim 1, wherein detected motion of the electronic device comprises at least one of movement of the electronic device in a direction or acceleration of the electronic device,
wherein detected motion of the mobile equipment comprises at least one of movement of the mobile equipment in a direction or acceleration of the mobile equipment, and
the tamper detection module is configured to subtract the detected motion of the mobile equipment from the detected motion of the electronic device for determining the difference between the detected motion of the electronic device and the detected motion of the mobile equipment based on the received data.

11. The system of claim 1, wherein the tamper detection module and the second motion sensor are configured to implement at least one anti-spoofing technique.

12. The system of claim 1, wherein the tamper detection module is configured to:
receive a secure instruction that indicates authorized access to the electronic device; and
disable implementation of the security action in response to receiving the secure instruction.

13. A method comprising:
detecting motion of an electronic device attached to mobile equipment;
detecting motion of the mobile equipment; and
determining a difference between the detected motion of the electronic device and the detected motion of the mobile equipment;
determining a tamper condition for the electronic device based on the detected motion of the electronic device and based on the determined difference; and
implementing a security action in response to determining the tamper condition.

14. The method of claim 13, wherein the mobile equipment is an automobile.

15. The method of claim 13, wherein detecting motion of the electronic device comprises using a first motion sensor, and
wherein detecting motion of the mobile equipment comprises using a second motion sensor.

16. The method of claim 13, further comprising indicating the tamper condition to an operator in response to determining the tamper condition.

17. The method of claim 13, further comprising implementing a security action at the electronic device in response to determining the tamper condition.

18. The method of claim 17, wherein implementing the security action comprises one of disabling power activation for the electronic device and preventing access to data stored on the electronic device.

19. The method of claim 13, wherein detected motion of the electronic device comprises at least one of movement of the electronic device in a direction or acceleration of the electronic device,
wherein detected motion of the mobile equipment comprises at least one of movement of the mobile equipment in a direction or acceleration of the mobile equipment, and
wherein determining a difference comprises subtracting the detected motion of the mobile equipment from the detected motion of the electronic device for determining the difference between the detected motion of the electronic device and the detected motion of the mobile equipment based on the received data.

20. The method of claim 13, further comprising:
receiving a secure instruction that indicates authorized access to the electronic device; and
disabling implementation of the security action in response to receiving the secure instruction.
